(19) United States
(12) Patent Application Publication
(10) Pub. No.: US 2026/0099266 A1
(43) Pub. Date: Apr. 9, 2026

(54) REDUCING STORAGE REPLICATION BY OPERATION LOGS IN CLOUD MULTIPLE ZONE ENVIRONMENTS

(71) Applicant: International Business Machines Corporation, Armonk, NY (US)

(72) Inventors: Dian Guo Zou, Beijing (CN); Zhi Li Guan, Beijing (CN); Xiao Li Yu, Beijing (CN); Peng Yang, Beijing (CN); Ke Feng Shao, Beijing (CN)

(21) Appl. No.: 18/909,079

(22) Filed: Oct. 8, 2024

(51) Int. Cl. G06F 3/06

(52) U.S. Cl. CPC G06F 3/0641; G06F 3/0608; G06F 3/067

(57) ABSTRACT

Examples described herein provide a computer-implemented method for reducing storage replication by operation logs in cloud multiple zone environments. The method includes deploying, at an operator engine, a custom resource, the custom resource defining multiple roles. The method further includes parsing the custom resource and calculating a calculated checksum for each of the multiple roles. The method further includes, for each of the multiple roles, comparing the calculated checksum to an expected checksum to determine whether a change in checksum has occurred. The method further includes, responsive to determining that the change in checksum has occurred for at least one of the roles of the multiple roles, executing role tasks for each of the at least one of the roles of the multiple roles for which the change in checksum has occurred.

### BACKGROUND

The present disclosure relates to computing environments, and more specifically, to reducing storage replication by operation logs in cloud multiple zone environments.

Containers provide an application layer approach to virtualization. A container packages together code and its dependencies, and the container can be run on a physical processing system. Multiple containers can be run on the same physical processing system. This approach uses less resources than a virtual machine approach to virtualization. Kubernetes is a container orchestration system that enables automating application deployment, scaling, and management of containers. Containers are useful in cloud computing environments because they package applications and their dependencies into lightweight, portable units that can run consistently across different infrastructures. This enables efficient resource utilization, faster deployment, and seamless scalability across distributed cloud computing environments.

### SUMMARY

According to an embodiment, a computer-implemented method for reducing storage replication by operation logs in cloud multiple zone environments is provided. The method includes deploying, at an operator engine, a custom resource, the custom resource defining multiple roles. The method further includes parsing the custom resource and calculating a calculated checksum for each of the multiple roles. The method further includes, for each of the multiple roles, comparing the calculated checksum to an expected checksum to determine whether a change in checksum has occurred. The method further includes, responsive to determining that the change in checksum has occurred for at least one of the roles of the multiple roles, executing role tasks for each of the at least one of the roles of the multiple roles for which the change in checksum has occurred.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a block diagram of a computing environment, according to an embodiment;

FIG. 2 illustrates a block diagram of a system for reducing storage replication by operation logs in cloud multiple zone environments, according to an embodiment;

FIG. 3 illustrates a flow diagram of a method for reducing storage replication by operation logs in cloud multiple zone environments is provided, according to an embodiment; and

FIG. 4 illustrates a flow diagram of a method 400 for reducing storage replication by operation logs in cloud multiple zone environments is provided, according to an embodiment.

### DETAILED DESCRIPTION

One or more embodiments described herein provide for reducing storage replication by operation logs in cloud multiple zone environments.

In the realm of cloud computing environments, containers may be used because containers package applications and their dependencies into lightweight, portable units that can run consistently across different infrastructures. This enables efficient resource utilization, faster deployment, and seamless scalability across distributed cloud computing environments.

Cloud computing environments can implement solutions for optimizing and managing certain aspects of the cloud environments. One such type of solution is a cloud automation solution designed to streamline and automate businesses processes. The cloud automation solution can include tools to manage workflows, decision-making, document processing, and more. Such solutions help businesses reduce operational inefficiencies by offering, for example, artificial intelligence (AI)-driven automation to handle tasks, such as content management, workflow automation, and robotic process automation RPA. A cloud automation solution can be deployed across different cloud environments, giving businesses flexibility in how they implement and scale automation solutions. One non-limiting example of a cloud automation solution is Cloud Pak for Automation (CP4A) by International Business Machines®.

Cloud computing environments can utilize Kubernetes, which is a container orchestration system that enables automating application deployment, scaling, and management of containers. Kubernetes utilizes an “operator,” which is an application management tool that helps automate the deployment, scaling, and management of containerized applications. Operators extend Kubernetes' capabilities by encapsulating the domain knowledge used to manage specific applications or services within a cloud computing environment.

For a cloud automation solution as described herein, operators are used to handle the deployment and lifecycle management of automation components. The operators automate operator tasks, such as provisioning resources (e.g., ensuring the required infrastructure, such as storage and networking, is configured), monitoring and healing (e.g., monitoring the state of the deployed components and implementing corrective actions automatically (e.g., restarting a failed service)), scaling and updating (e.g., scaling applications up or down and applying updates or patches), automating complex tasks (e.g., reducing manual intervention in managing applications, ensuring smoother operations), and/or the like, including combinations and/or multiples thereof.

Operators can define roles, which refer to the specific permissions and access controls that operators are assigned to execute their respective operator tasks. These roles determine what actions an operator can take within a Kubernetes environment, ensuring that the operator functions securely and efficiently. An operator may have roles that allow it to manage persistent storage for applications, handle scaling of application resources, perform self-healing actions (e.g., restarting failed services), updating or patching software components, and/or the like, including combinations and/or multiples thereof. Roles provide fine-grained control over what an operator can manage, ensuring operator tasks are performed securely, consistently, and within the scope defined by a system administrator or other authority.

Operators can oversee custom resources. A custom resource (CR) extends the Kubernetes application programming interface (API) to allow for the definition and management of custom configurations specific to a particular application or service. Custom resources work in tandem with operators, which are responsible for watching the custom resources and taking appropriate actions. Custom resources allow developers to define a desired state of their applications or components in a Kubernetes environment. For example, a CR could be used to define how certain automation services or workflows should be deployed and managed. The operator reads this CR and ensures that Kubernetes deploys and maintains the resources accordingly.

In modern cloud computing environments, Kubernetes clusters are widely utilized to manage containerized applications. These clusters are often deployed across multiple zones to ensure high availability and redundancy. A multi-zone region (MZR) configuration helps distribute data across different geographical zones within a cloud provider's infrastructure, enhancing load balancing and fault tolerance. However, this setup can lead to significant data transmission between zones, especially when using storage clusters like OpenShift container storage (OCS) in a multi-zone environment.

One of the primary challenges faced by users in such environments is the linear increase in inter-zone data transmission. This increase results in substantial costs due to the data transfer charges imposed by cloud providers. Existing approaches to mitigate these costs, such as data compression and deduplication, offer limited relief and do not fully address the issue in a multi-zone setup. Consequently, there is a need for more effective solutions to reduce data transmission and associated costs in cloud environments with multiple zones.

One or more embodiments described herein provide a novel approach to reducing storage replication by operation logs in cloud multiple zone environments. By introducing a mechanism for calculating checksums for each role defined in a custom resource (CR), one or more embodiments can identify and execute role tasks (also referred to simply as “tasks”) for the changed roles while bypassing non-changed roles without executing role tasks for those roles. This targeted execution significantly reduces the volume of generated logs and, consequently, the data transmission between zones, thus improving computer system functionality in distributed computing systems. One or more embodiments ensures that only the necessary tasks are performed, optimizing resource utilization and minimizing costs for end users.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

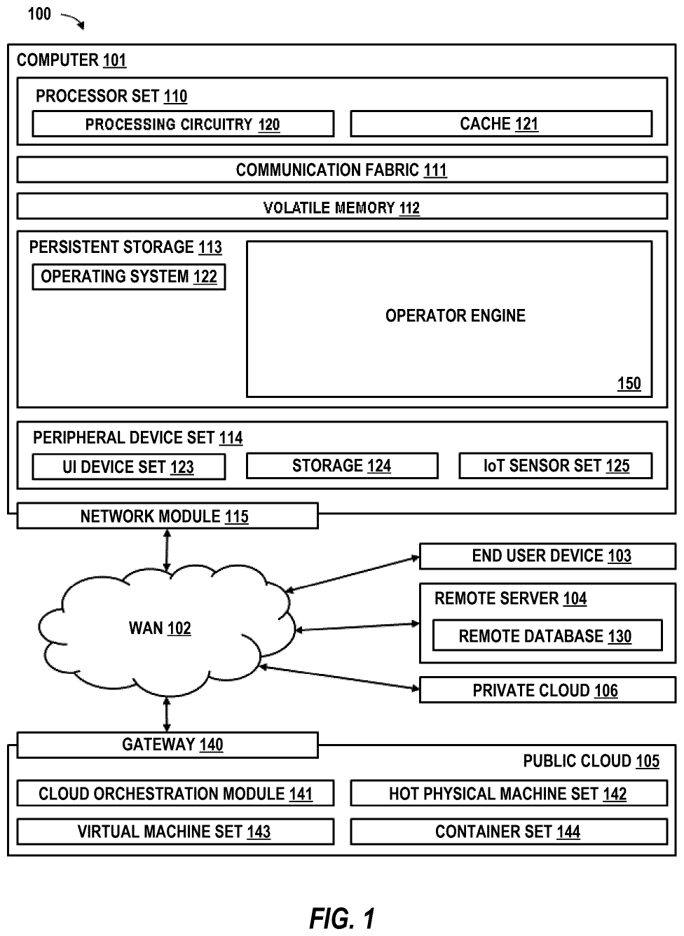

FIG. 1 illustrates a computing environment 100, according to an embodiment. Computing environment 100 contains an example of an environment for the execution of at least some of the computer code involved in performing the inventive methods, such as an operator engine 150 for generating parameters for statistical timing analysis of a circuit. In addition to the operator engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the operator engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the operator engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the operator engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

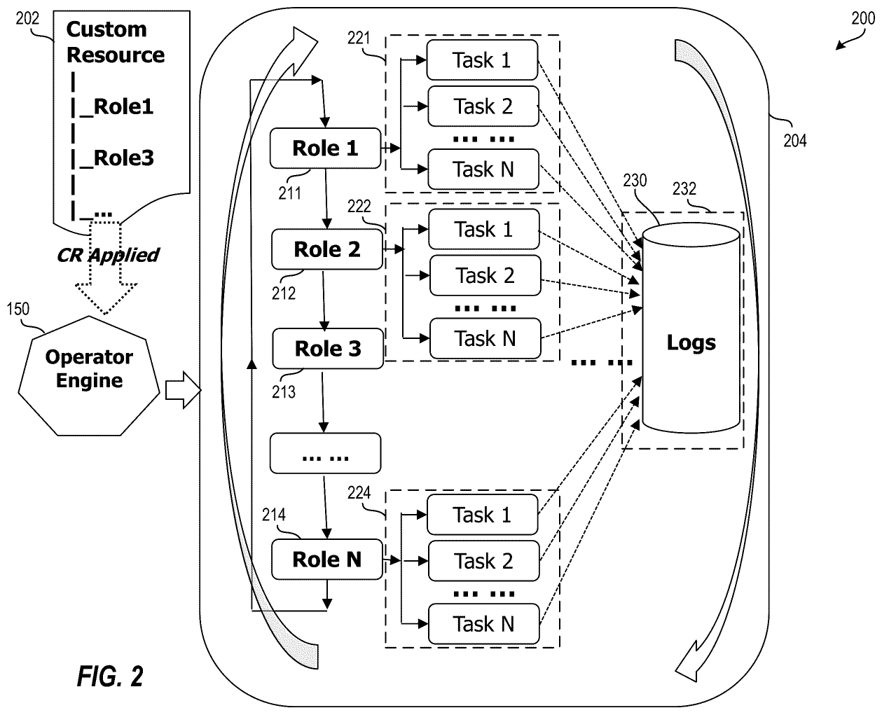

FIG. 2 illustrates a system 200 for reducing storage replication by operation logs, such as the log 230, in cloud multiple zone environments, according to an embodiment. The system 200 includes an operator engine 150, a custom resource 202, and a logging mechanism 232 for generating the log 230. The logging mechanism 232 is responsible for generating logs for the tasks executed by the operator engine 150, specifically for the roles that have undergone changes as identified by a checksum comparison. By focusing on logging only the changed roles, the logging mechanism 232 significantly reduces the volume of generated logs, thereby optimizing storage and minimizing data transmission between zones.

The custom resource 202 defines multiple roles, such as Role 1 211, Role 2 212, Role 3 213, and Role N 214. Each role includes multiple tasks 221 (e.g., Task 1, Task 2, and Task N), which are examples of role tasks. The custom resource 202 is applied to the operator engine 150, which parses the custom resource 202 and calculates a checksum for each of the multiple roles 211-214. Particularly, the operator engine 150 compares the calculated checksum for each role (e.g., roles 211-214) to an expected checksum to determine whether a change in checksum has occurred. A change in checksum represents a change to a role. If a change in checksum is detected for a role, the operator engine 150 executes the tasks associated with that role. For example, if a change is detected in Role 1 211, the operator engine 150 will execute the multiple tasks 221 (e.g., Task 1, Task 2, and Task N) for Role 1 211. Similarly, if a change is detected in Role 2 212, the operator engine 150 will execute the tasks for Role 2, and so on. If no change to the checksum is detected, the operator engine 150 skips the role. For example, if the calculated checksum for Role 3 213 matches an expected checksum for Role 3 213, the operator engine 150 bypasses Role 3 213 and does not execute any tasks (not shown) associated with Role 3 213.

Entries in the log 230 are generated for the tasks executed by the operator engine 150 but not for any tasks of bypassed roles. By only executing the tasks for the roles with changed checksums, the system 200 significantly reduces the volume of generated logs and, consequently, the data transmission between zones. This targeted execution improves computer system functionality in distributed computing systems by optimizing resource utilization and minimizing costs for end users.

Overall, FIG. 2 demonstrates how the system 200 effectively reduces storage replication by operation logs in cloud multiple zone environments by introducing a mechanism for calculating checksums for each role defined in a custom resource and executing only the changed roles.

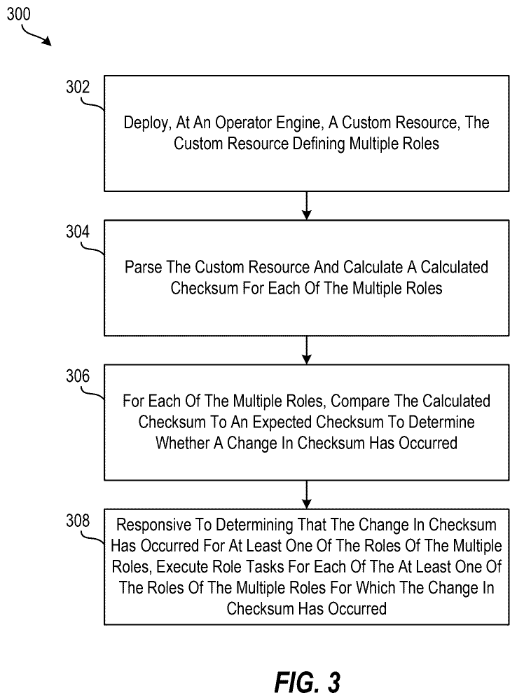

Turning now to FIG. 3, a flow diagram of a method 300 for reducing storage replication by operation logs in cloud multiple zone environments is provided, according to an embodiment. The method 300 can be performed by any suitable computing system, device, or environment, such as those described herein. The method 300 is now described with reference to the computing environment 100, and particularly the operator engine 150, but is not so limited. For example, the method 300 is performed by the operator engine 150 and involves several steps to optimize resource utilization and minimize data transmission costs.

At block 302, the method begins with deploying, at the operator engine 150, a custom resource (e.g., the custom resource 202). The custom resource defines multiple roles (e.g., Role 1 211, Role 2 212, Role 3 213, Role N 214), each of which may have specific tasks associated with it. This deployment sets the stage for the operator engine 150 to manage and monitor the roles defined in the custom resource.

At block 304, the operator engine 150 parses the custom resource and calculates a checksum for each of the multiple roles. This involves analyzing the custom resource to identify the roles and then computing a unique checksum for each role. The checksum serves as a digital fingerprint that represents the current state of the role.

At block 306, for each of the multiple roles, the operator engine compares the calculated checksum to an expected checksum to determine whether a change in checksum has occurred. The expected checksum is a previously stored value that represents the last known state of the role. By comparing the calculated checksum to the expected checksum, the operator engine can detect any changes in the role's state.

At block 308, responsive to determining that a change in checksum has occurred for at least one of the roles (that is, a change in the role's state occurred), the operator engine 150 executes the role tasks for each of the roles for which the change in checksum has occurred. For example, if it is determined that a change in checksum occurred for Role 2 212, the operator engine 150 executes the tasks 222 associated with Role 2 212. However, according to one or more embodiments, the operator engine 150 bypasses executing tasks for any roles that do not have a changed checksum. For example, if it is determined that no change in checksum occurred for Role 1 211, the operator engine 150 bypasses executing (e.g., does not execute) the tasks 221 associated with Role 211. This targeted execution ensures that only the tasks associated with the changed roles are performed, thereby reducing the volume of generated logs and minimizing data transmission between zones.

Overall, FIG. 3 demonstrates an efficient approach to reducing storage replication by operation logs in cloud multiple zone environments. By calculating and comparing checksums for each role defined in a custom resource 202, the method 300 ensures that tasks are executed for roles with changed checksums but not those with unchanged checksums, thereby optimizing resource utilization, reducing logging, and reducing costs for end users.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

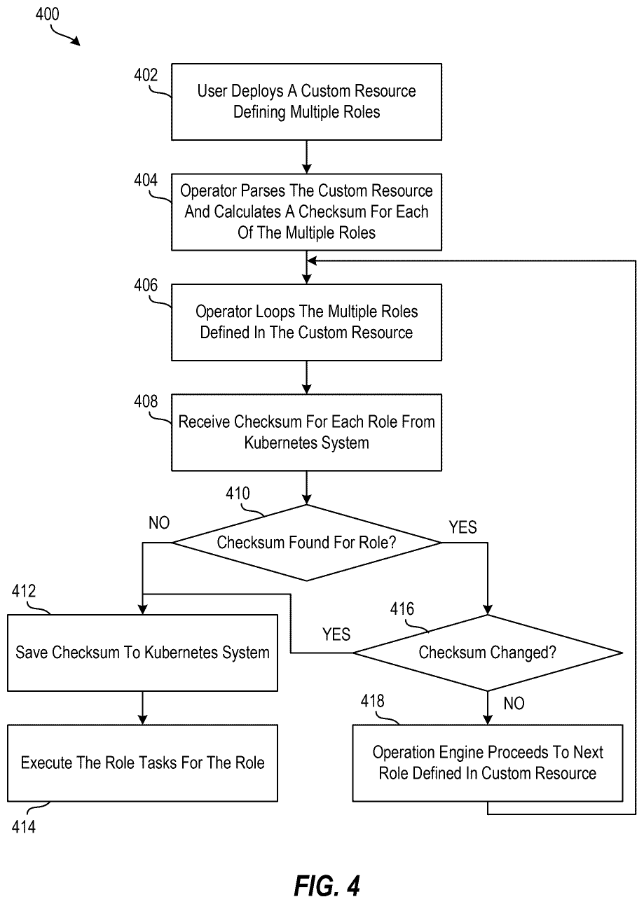

Turning now to FIG. 4, a flow diagram of a method 400 for reducing storage replication by operation logs in cloud multiple zone environments is provided, according to an embodiment. The method 400 can be performed by any suitable computing system, device, or environment, such as those described herein. The method 400 is now described with reference to the computing environment 100, and particularly the operator engine 150, but is not so limited. For example, the method 400 is performed by the operator engine 150 and involves several key steps to optimize resource utilization and minimize data transmission costs.

At block 402, the method 400 begins with a user deploying a custom resource (e.g., the custom resource 202) that defines multiple roles. This custom resource serves as the blueprint for the operator engine to manage and monitor the roles defined within it.

At block 404, the operator engine 150 parses the custom resource and calculates a checksum for each of the multiple roles. This step involves analyzing the custom resource to identify the roles and then computing a unique checksum for each role. The checksum serves as a digital fingerprint that represents the current state of the role.

At block 406, the operator engine loops through the multiple roles defined in the custom resource. This looping mechanism ensures that each role is individually processed and monitored for changes.

At block 408, the operator engine receives the checksum for each role, such as from a Kubernetes system. The received checksum is an expected checksum. This step involves retrieving the previously stored checksums that represent the last known state of each role.

At decision block 410, the operator engine 150 checks whether a checksum is found for the role. That is, the operator engine 150 checks whether an expected checksum was received from the Kubernetes system. If no checksum is found (decision block 410 “No”), the method 400 proceeds to block 412, where the operator engine 150 saves the calculated checksum to the Kubernetes system for the role. Following this, at block 414, the operator engine 150 executes the role tasks for the role.

If a checksum is found (decision block 410 “Yes”), the method 400 proceeds to decision block 416, where the operator engine 150 checks whether the checksum has changed. That is, the operator engine 150 compares the calculated checksum to the expected checksum received from the Kubernetes system. If the checksum has changed (decision block 416 “Yes”), the method 400 proceeds to block 412, where the operator engine 150 saves the calculated checksum to the Kubernetes system for the role. If the checksum has not changed (decision block 416 “No”), the method 400 proceeds to block 418, where the operator engine 150 proceeds to the next role defined in the custom resource without executing the role tasks for the current role.

Overall, FIG. 4 demonstrates an efficient approach to reducing storage replication by operation logs in cloud multiple zone environments. By calculating and comparing checksums for each role defined in a custom resource 202, the method 400 ensures that tasks are executed for roles with changed checksums but not those with unchanged checksums, thereby optimizing resource utilization, reducing logging, and reducing costs for end users.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

One or more embodiments described herein significantly improves the functioning of a computer in cloud multiple zone environments by optimizing resource utilization and reducing unnecessary data transmission. Here are several non-limiting examples of how one or more embodiments enhances computer functionality, although others may be possible.
Targeted Execution of Tasks: By calculating checksums for each role defined in a custom resource and comparing them to expected checksums, one or more embodiments can identify which roles have changed. This allows the operator engine 150 to execute tasks for the roles that have changed while bypassing the execution of tasks for roles that have not changed. This targeted execution reduces the computational overhead and ensures that the system's resources are used efficiently.
Reduction in Generated Logs: Existing approaches generate logs for roles regardless of whether they have changed or not. One or more embodiments reduces the volume of generated logs by creating logs for the roles that have changed without creating logs for non-executed tasks. This reduction in log generation minimizes the storage demands and decreases the data transmission between zones, leading to lower operational costs and improved system performance.
Minimized Data Transmission: In multi-zone cloud environments, data transmission between zones can be costly and time-consuming. By reducing the volume of generated logs and only transmitting data for changed roles, one or more embodiments minimizes the inter-zone data transmission. This not only reduces the costs associated with data transfer but also improves the overall efficiency and speed of the system.
Enhanced Resource Utilization: One or more embodiments provides for bypassing the execution of tasks for roles with checksums that have not changed, optimizing the use of computational resources, such as CPU, memory, and storage. This efficient resource utilization leads to better performance and scalability of the system, allowing it to handle larger workloads and more complex operations without degradation in performance.
Improved System Responsiveness: By focusing on the execution of tasks for changed roles and reducing operations by bypassing execution of tasks for roles that do not have changed checksums, one or more embodiments becomes more responsive. This improved responsiveness is useful for improving real-time applications and services, where quick and efficient processing of tasks is useful.

Overall, one or more embodiments enhance the functioning of a computer by introducing a more efficient and cost-effective method for managing operation logs in cloud multiple zone environments. One or more embodiments optimizes resource utilization, reduces logs and data transmission, and improves system performance.

While the foregoing is directed to embodiments of the present disclosure, other and further embodiments of the present disclosure may be devised without departing from the basic scope thereof, and the scope thereof is determined by the claims that follow.

1. A computer-implemented method for reducing storage replication by operation logs in cloud multiple zone environments, the method comprising:
deploying, at an operator engine, a custom resource, the custom resource defining multiple roles;
parsing the custom resource and calculating a calculated checksum for each of the multiple roles;
for each of the multiple roles, comparing the calculated checksum to an expected checksum to determine whether a change in checksum has occurred, wherein, responsive to determining that no expected checksum is found for a role, saving the calculated checksum to the container orchestration system for that role and then executing the role tasks for that role;
responsive to determining that the change in checksum has occurred for at least one of the roles of the multiple roles, saving the calculated checksum to a container orchestration system and, subsequent to the saving, executing role tasks for each of the at least one of the roles of the multiple roles for which the change in checksum has occurred; and
responsive to determining that the change in checksum has occurred for at least one of the roles of the multiple roles, generating a log event associated with at least one of the role tasks for which the change in checksum has occurred without generating log events for bypassed roles for which no change in checksum occurred.

2. (canceled)

3. The computer-implemented method of claim 1, further comprising, responsive to determining that the change in checksum has not occurred for another of the roles of the multiple roles, proceeding to a next role of the multiple roles defined in the custom resource.

4. The computer-implemented method of claim 3, wherein proceeding to the next role comprises not executing role tasks for the other of the roles of the multiple roles for which the change in checksum did not occur.

5. The computer-implemented method of claim 1, wherein the expected checksum is received from the container orchestration system.

6. The computer-implemented method of claim 5, further comprising saving the calculated checksum as the expected checksum.

7. The computer-implemented method of claim 6, wherein saving the calculated checksum as the expected checksum comprises saving the calculated checksum as the expected checksum to the container orchestration system.

8. A system comprising:
a memory comprising computer readable instructions; and
a processing device for executing the computer readable instructions, the computer readable instructions controlling the processing device to perform operations for reducing storage replication by operation logs in cloud multiple zone environments, the operations comprising:
deploying, at an operator engine, a custom resource, the custom resource defining multiple roles;
parsing the custom resource and calculating a calculated checksum for each of the multiple roles;
for each of the multiple roles, comparing the calculated checksum to an expected checksum to determine whether a change in checksum has occurred, wherein, responsive to determining that no expected checksum is found for a role, saving the calculated checksum to the container orchestration system for that role and then executing the role tasks for that role;
responsive to determining that the change in checksum has occurred for at least one of the roles of the multiple roles, saving the calculated checksum to a container orchestration system and, subsequent to the saving, executing role tasks for each of the at least one of the roles of the multiple roles for which the change in checksum has occurred; and
responsive to determining that the change in checksum has occurred for at least one of the roles of the multiple roles, generating a log event associated with at least one of the role tasks for which the change in checksum has occurred without generating log events for bypassed roles for which no change in checksum occurred.

9. (canceled)

10. The system of claim 8, wherein the operations further comprise, responsive to determining that the change in checksum has not occurred for another of the roles of the multiple roles, proceeding to a next role of the multiple roles defined in the custom resource.

11. The system of claim 10, wherein proceeding to the next role comprises not executing role tasks for the other of the roles of the multiple roles for which the change in checksum did not occur.

12. The system of claim 8, wherein the expected checksum is received from the container orchestration system.

13. The system of claim 12, wherein the operations further comprise saving the calculated checksum as the expected checksum.

14. The system of claim 13, wherein saving the calculated checksum as the expected checksum comprises saving the calculated checksum as the expected checksum to the container orchestration system.

15. A computer program product for reducing storage replication by operation logs in cloud multiple zone environments, the computer program product comprising:
a set of one or more computer-readable storage media;
program instructions, collectively stored in the set of one or more storage media, for causing a processor set to perform the following computer operations:
deploying, at an operator engine, a custom resource, the custom resource defining multiple roles;
parsing the custom resource and calculating a calculated checksum for each of the multiple roles;
for each of the multiple roles, comparing the calculated checksum to an expected checksum to determine whether a change in checksum has occurred, wherein, responsive to determining that no expected checksum is found for a role, saving the calculated checksum to the container orchestration system for that role and then executing the role tasks for that role;
responsive to determining that the change in checksum has occurred for at least one of the roles of the multiple roles, saving the calculated checksum to a container orchestration system and, subsequent to the saving, executing role tasks for each of the at least one of the roles of the multiple roles for which the change in checksum has occurred; and
responsive to determining that the change in checksum has occurred for at least one of the roles of the multiple roles, generating a log event associated with at least one of the role tasks for which the change in checksum has occurred without generating log events for bypassed roles for which no change in checksum occurred.

16. (canceled)

17. The computer program product of claim 15, wherein the operations further comprise, responsive to determining that the change in checksum has not occurred for another of the roles of the multiple roles, proceeding to a next role of the multiple roles defined in the custom resource.

18. The computer program product of claim 17, wherein proceeding to the next role comprises not executing role tasks for the other of the roles of the multiple roles for which the change in checksum did not occur.

19. The computer program product of claim 15, wherein the expected checksum is received from the container orchestration system.

20. The computer program product of claim 19, wherein the operations further comprise saving the calculated checksum as the expected checksum.
